(19) United States
(12) Patent Application Publication
(10) Pub. No.: US 2026/0220258 A1
(43) Pub. Date: Jul. 30, 2026

(54) VERIFICATION BASED ON PROCESS PATH INTEGRITY

(71) Applicant: JAMF Software, LLC, Minneapolis, MN (US)

(72) Inventors: Nir Avraham, Yavne (IL); Jonathan Jehuda David, Yavne (IL); Yuan Shen, Milpitas, CA (US)

(21) Appl. No.: 19/038,005

(22) Filed: Jan. 27, 2025

(51) Int. Cl. G06F 21/55; G06F 21/57

(52) U.S. Cl. CPC G06F 21/554; G06F 21/577; G06F 2221/033

(57) ABSTRACT

In certain aspects, methods include extracting, from a firmware associated with a mobile computing device, a set of legitimate process executable paths. The methods include retrieving, from the mobile computing device, diagnostic process information of processes running on the mobile computing device. The methods include identifying, based on determining a target executable process of the diagnostic process information retrieved from the mobile computing device is matchless with the set of legitimate process executable paths, the target executable process as a potentially suspicious process. The methods include analyzing the potentially suspicious process to determine legitimacy. The methods include triggering, based on determining the potentially suspicious process as an illegitimate process, an alert.

### TECHNICAL FIELD

The present disclosure generally relates to security on mobile devices, and more specifically relates to verification based on process path integrity.

### BACKGROUND

In the rapidly evolving landscape of mobile operating systems, security remains a critical concern due to the growing sophistication and frequency of cyber threats. Mobile OSes, much like desktop systems, require robust security measures to protect against unauthorized access and malicious activities. However, unlike more open systems, many mobile operating systems impose stringent restrictions on system-level access. These restrictions, while bolstering overall system security against external threats, also limit the capabilities of legitimate security applications to perform comprehensive diagnostics and direct process inspections.

Traditional security approaches often rely on extensive system access to monitor, analyze, and manage running processes on mobile devices, which is not feasible within the constrained environment of many mobile OSes. These mobile operating systems do not allow applications or users to inspect running processes freely. Accordingly, there is a significant need for innovative security tools specifically designed for mobile environments that can operate effectively within these restrictions.

The description provided in the background section should not be assumed to be prior art merely because it is mentioned in or associated with the background section. The background section may include information that describes one or more aspects of the subject technology.

### SUMMARY

In certain instances, the present disclosure provides systems and methods that enable a “manager” or “primary” mobile device or a security service to perform selected MDM functions with respect to one or more “managed” or “secondary” mobile devices, such as mobile computing devices.

In certain aspects, the present disclosure addresses traditional challenges by utilizing outputs permissible under mobile OS security policies for diagnostic purposes. Specifically, in certain aspects, the present disclosure correlates process paths and diagnostic process lists to detect discrepancies that may indicate suspicious or malicious activities. In certain aspects, the present disclosure involves analyzing process paths against a predefined list of expected paths and examining additional diagnostic information to identify processes that do not conform to established benign patterns.

In certain aspects, the disclosed technology provides systems and methods for verification based on process path integrity, providing an essential tool for enhancing the security posture of devices operating under various mobile operating systems. The disclosed technology supports early detection of potential security threats and facilitates broader security analysis and response strategies, tailored to the unique security environments of mobile operating systems.

According to certain aspects of the present disclosure, a computer-implemented method is provided. The method includes, extracting, from a firmware associated with a mobile computing device, a set of legitimate process executable paths. The method includes retrieving, from the mobile computing device, diagnostic process information of processes running on the mobile computing device. The method includes identifying, based on determining a target executable process of the diagnostic process information retrieved from the mobile computing device is matchless with the set of legitimate process executable paths, the target executable process as a potentially suspicious process. The method includes analyzing the potentially suspicious process to determine legitimacy. The method includes triggering, based on determining the potentially suspicious process as an illegitimate process, an alert.

According to other aspects of the present disclosure, a system is provided. The system includes a memory comprising instructions and a processor configured to execute the instructions which, when executed, cause the processor to extract, from a firmware associated with a mobile computing device, a set of legitimate process executable paths. The processor is configured to execute the instructions which, when executed, cause the processor to retrieve, from the mobile computing device, diagnostic process information of processes running on the mobile computing device. The processor is configured to execute the instructions which, when executed, cause the processor to identify, based on determining a target executable process of the diagnostic process information retrieved from the mobile computing device is matchless with the set of legitimate process executable paths, the target executable process as a potentially suspicious process. The processor is configured to execute the instructions which, when executed, cause the processor to analyze the potentially suspicious process to determine legitimacy. The processor is configured to execute the instructions which, when executed, cause the processor to trigger, based on determining the potentially suspicious process as an illegitimate process, an alert.

According to other aspects of the present disclosure, a non-transitory machine-readable storage medium comprising machine-readable instructions for causing a processor to execute a method is provided. The method includes, extracting, from a firmware associated with a mobile computing device, a set of legitimate process executable paths. The method includes retrieving, from the mobile computing device, diagnostic process information of processes running on the mobile computing device. The method includes identifying, based on determining a target executable process of the diagnostic process information retrieved from the mobile computing device is matchless with the set of legitimate process executable paths, the target executable process as a potentially suspicious process. The method includes analyzing the potentially suspicious process to determine legitimacy. The method includes triggering, based on determining the potentially suspicious process as an illegitimate process, an alert.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. It should be noted that although various aspects may be described herein with reference to corporate, organization, healthcare, retail, or educational settings, these are examples only and are not to be considered limiting. The teachings of the present disclosure may be applied to any mobile device environments, including but not limited to organization environments, home environments, healthcare environments, retail environments, educational environments, corporate environments, and other appropriate environments. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for verifying process path integrity.

FIG. 2 is a block diagram illustrating the example at least one mobile computing device, mobile device management service, security service, push notification service, and database from the architecture of FIG. 1 according to certain aspects of the disclosure.

FIG. 3 illustrates an example process for verifying process path integrity, and the authentication service of FIG. 2.

FIG. 4 illustrates a block diagram depicting path extraction from a firmware and real-time process monitoring for a continuous cycle of verification, which, in certain aspects, can be implemented with the example process of FIG. 3.

FIG. 5 illustrates a block diagram depicting systematic visualization of precision and adaptability in maintaining security integrity of mobile operating systems of the example process of FIG. 3.

FIG. 6 is a block diagram depicting a database utilizing historical processes.

FIG. 7 illustrates an example process depicting initial steps of anomaly detection of the example process of FIG. 3.

FIG. 8 illustrates an example process depicting further steps of the example process of FIG. 7.

FIG. 9 is block diagram illustrating an example computer system with which the at least one mobile computing device, the mobile device management service, the security service, the push notification service, and the database of FIG. 2 can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

The disclosed technology provides systems and methods for verifying process path integrity.

The disclosed technology is designed to enhance the security of devices operating under various mobile operating systems by verifying the integrity of process paths. Addressing the unique constraints and security challenges inherent in mobile OS environments, the disclosed technology provides a novel solution for detecting and managing suspicious or malicious processes without requiring extensive system-level access, which is typically restricted in these settings.

The disclosed technology provides innovative approaches to utilize permissible diagnostic outputs for security analysis. By correlating process paths obtained from system diagnostics with a comprehensive database of validated paths, the disclosed technology is capable of identifying anomalies that may indicate unauthorized activities or security breaches. The disclosed technology is particularly suited to mobile operating systems where traditional direct monitoring techniques are not feasible due to stringent security restrictions.

The disclosed technology provides advantages over traditional systems and methods. For example, the disclosed technology monitors and retrieves process path data from the diagnostic outputs allowed by the mobile OS, ensuring compliance with security and privacy standards. The disclosed technology also advantageously confirms the authenticity of each process by cross-referencing each process path against a trusted repository of known legitimate paths, which includes system directories and validated firmware files. The disclosed technology also advantageously verifies whether the paths align with executable files recognized in the official firmware or other trusted sources, adding a robust layer of verification. The disclosed technology refines the accuracy of detection and reduces false positives by implementing statistical analysis to evaluate the commonality or rarity of the process paths observed to determine their likelihood of being suspicious. The disclosed technology advantageously transmits alerts, upon detection of a process that fails to meet the verification criteria, which facilitates timely intervention and further investigative actions.

The disclosed technology significantly advances the field of mobile security by providing methods that are both effective in identifying potential security threats and compliant with the restrictive access policies typical of mobile operating systems. The disclosed technology offers substantial benefits for both individual users and organizations by enhancing the ability to detect and respond to security issues in a timely and effective manner.

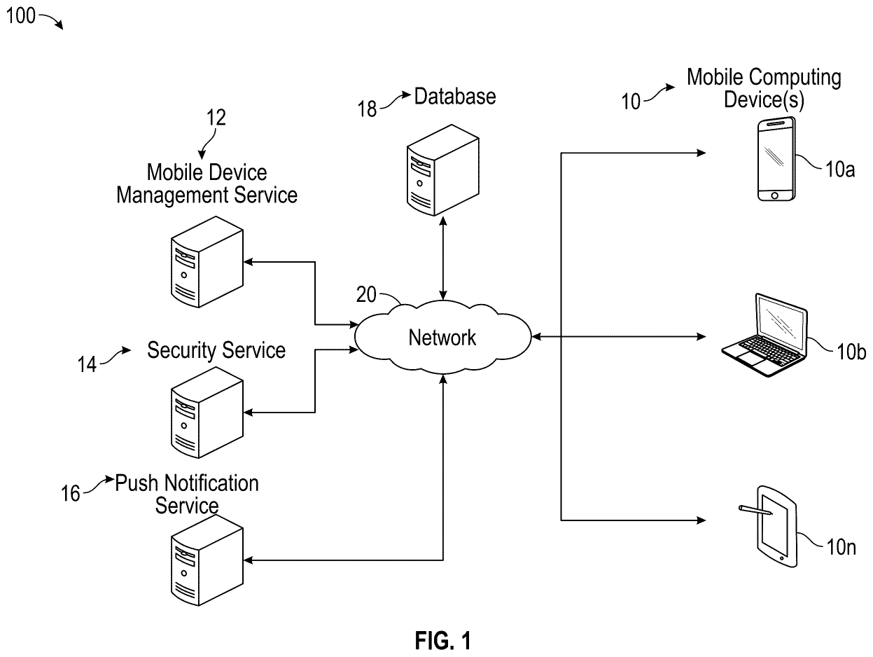

FIG. 1 illustrates an example architecture 100 for verifying process path integrity. For example, the architecture 100 includes at least one mobile computing device 10, such as a first mobile computing device 10a and a second mobile computing device 10b to an nth mobile computing device 10n, a mobile device management service 12, a security service 14, a push notification service 16, and a database 18 all connected over a network 20. In certain aspects, the mobile device management service 12 may be connected to the push notification service 16 over a separate network.

The mobile device management service 12 can be a device having an appropriate processor, memory, and communications capability for communicating with the at least one mobile computing device 10, the security service 14, the push notification service 16, and the database 18. For purposes of load balancing, the mobile device management service 12 may include multiple servers. The security service 14 can be a device having an appropriate processor, memory, and communications capability for communicating with the at least one mobile computing device 10, the mobile device management service 12, the push notification service 16, and the database 18. For purposes of load balancing, the security service 14 may include multiple servers. In certain aspects, the security service 14 can be hosted on the mobile device management service 12. The push notification service 16 can be a device having an appropriate processor, memory, and communications capability for communicating with the at least one mobile computing device 10, the mobile device management service 12, the security service 14, and the database 18. The database 18 can be a device having an appropriate processor, memory, and communications capability for communicating with the at least one mobile computing device 10, the mobile device management service 12, and the security service 14.

The at least one mobile computing device 10, such as the first mobile computing device 10a and the second mobile computing device 10b, to which the mobile device management service 12 communicates with over the network 20 via the push notification service 16, can be, for example, a tablet computer, a mobile phone, a mobile computer, a laptop computer, a portable media player, an electronic book (eBook) reader, or any other device having appropriate processor, memory, and communications capabilities. In certain aspects, the mobile device management service 12, the security service 14, the push notification service 16, and the database 18 can be a cloud computing server of an infrastructure-as-a-service (IaaS) and be able to support a platform-as-a-service (PaaS) and software-as-a-service (SaaS) services.

It should be noted that the present disclosure does not limit the at least one mobile computing device 10 to any particular configuration or number of devices. In certain aspects, a different number of mobile computing devices may be present.

The network 20 can include, for example, any one or more of a personal area network (PAN), a local area network (LAN), a campus area network (CAN), a metropolitan area network (MAN), a wide area network (WAN), a broadband network (BBN), the Internet, and the like. Further, the network 20 can include, but is not limited to, any one or more of the following network topologies, including a bus network, a star network, a ring network, a mesh network, a star-bus network, tree or hierarchical network, and the like.

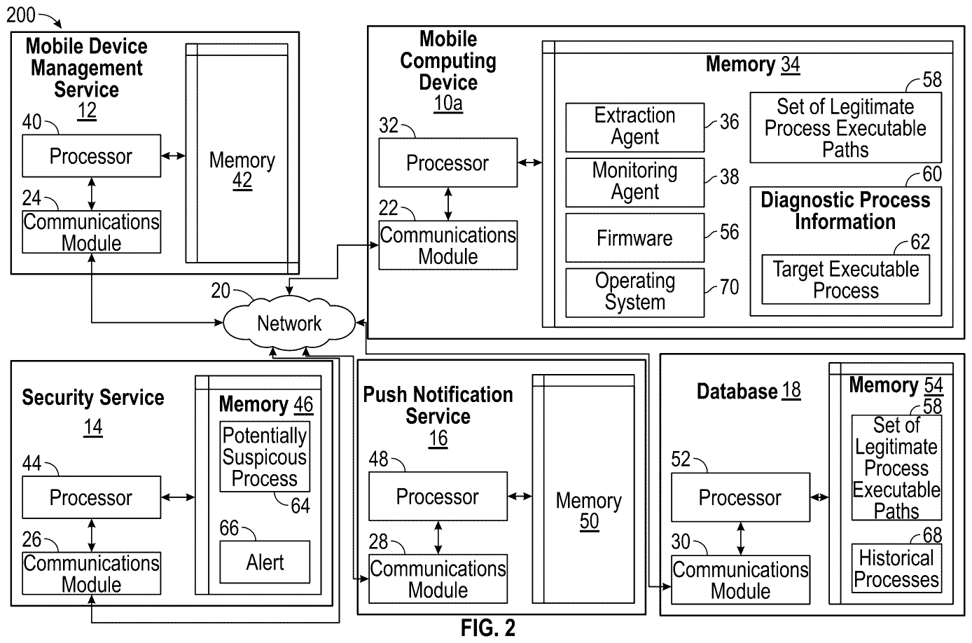

FIG. 2 is a block diagram illustrating examples of the at least one mobile computing device 10, such as a first mobile computing device 10a, the mobile device management service 12, the security service 14, the push notification service 16, and the database 18 in the architecture 100 of FIG. 1 according to certain aspects of the disclosure. It should be understood that for purposes of explanation the at least one mobile computing device 10 is described, but any number of the at least one mobile computing device 10 could be used.

The at least one mobile computing device 10, such as a first mobile computing device 10a, the mobile device management service 12, the security service 14, the push notification service 16, and the database 18 are connected over the network 20 via respective communication modules 22, 24, 26, 28, 30. The communications modules 22, 24, 26, 28, 30 are configured to interface with the network 20 to send and receive information, such as data, requests, responses, and commands to other devices on the network 20. The communications modules 22, 24, 26, 28, 30 can be, for example, modems or Ethernet cards.

The at least one mobile computing device 10, such as a first mobile computing device 10a, includes a processor 32, the communications module 22, and a memory 34 that includes an extraction agent 36 and a monitoring agent 38. The processor 32 of the at least one mobile computing device 10 is configured to execute instructions, such as instructions physically coded into the processor 32, instructions received from software in the memory 34, or a combination of both. Although the extraction agent 36 and the monitoring agent 38 are described as separate agents, it should be understood that in certain aspects a single agent can be utilized to perform the functions of both the extraction agent 36 and the monitoring agent 38.

The mobile device management service 12 includes a processor 40, the communications module 24, and a memory 42 that includes. The processor 40 of the mobile device management service 12 is configured to execute instructions, such as instructions physically coded into the processor 40, instructions received from software in the memory 42, or a combination of both.

The security service 14 includes a processor 44, the communications module 26, and a memory 46. The processor 44 of the security service 14 is configured to execute instructions, such as instructions physically coded into the processor 44, instructions received from software in the memory 46, or a combination of both. In certain aspects, the processor 44 of the security service 14 is configured to update the set of legitimate process executable paths 58 stored in the database 18 responsive to release of a new version of a firmware 56 associated with the at least one mobile computing device 10. In certain aspects, the processor 44 of the security service 14 is configured to analyze the potentially suspicious process 64 to determine legitimacy. In certain aspects, the processor 44 of the security service 14 is configured to trigger, based on determining the potentially suspicious process 64 as an illegitimate process, an alert 66.

The push notification service 16 includes a processor 48, the communications module 28, and a memory 50. The processor 48 of the push notification service 16 is configured to execute instructions, such as instructions physically coded into the processor 48, instructions received from software in the memory 50, or a combination of both.

The database 18 includes a processor 52, the communications module 30, and a memory 54. The processor 52 of the database 18 is configured to execute instructions, such as instructions physically coded into the processor 52, instructions received from software in the memory 54, or a combination of both. In certain aspects, the database 18 is configured to store both the set of legitimate process executable paths 58 and the historical processes 68. Although the database 18 is described as storing both the set of legitimate process executable paths 58 and the historical processes 68, separate databases could be implemented such that one database stores the set of legitimate process executable paths 58 and another database stores the historical processes 68.

It should be noted that although various embodiments may be described herein with reference to organization settings, this is for example only and not to be considered limiting. The teachings of the present disclosure may be applied in other mobile device environments, including but not limited to home environments, corporate environments, retail environments, government environments, organization environments, and other appropriate environments.

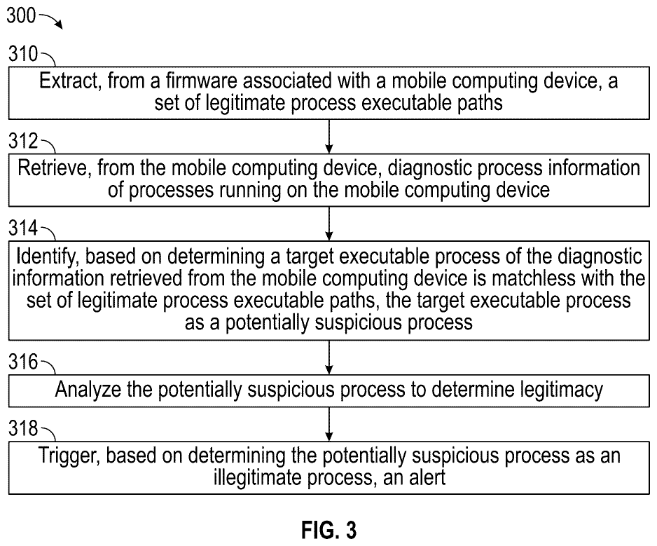

FIG. 3 illustrates an example process 300 for verifying process path integrity using the at least one mobile computing device 10, such as a first mobile computing device 10a, the mobile device management service 12, the security service 14, the database 18, and, in certain aspects, the push notification service 16. While FIG. 3 is described with reference to FIG. 2, it should be understood that the process steps of FIG. 3 may be performed by other systems.

The process 300 begins by proceeding to step 310 when the processor 44 of the security service 14 extracts, via the extraction agent 36, a firmware 56 associated with the at least one mobile computing device 10, a set of legitimate process executable paths 58. As depicted at step 312, the processor 44 of the security service 14 retrieves, via the monitoring agent 38, from the at least one mobile computing device 10, diagnostic process information 60 of processes running on the at least one mobile computing device 10. In certain aspects, the processor 44 of the security service 14 can store the set of legitimate process executable paths 58 in the database 18.

As illustrated at step 314, the processor 44 of the security service 14 identifies, based on determining a target executable process 62 of the diagnostic information 60 retrieved from the at least one mobile computing device 10 is matchless with the set of legitimate process executable paths 58, the target executable process 62 as a potentially suspicious process 64. The processor 44 of the security service 14 analyzes the potentially suspicious process 64 to determine legitimacy, as illustrated at step 316. As depicted at step 318, processor 44 of the security service 14 triggers, based on determining the potentially suspicious process 64 as an illegitimate process, an alert 66.

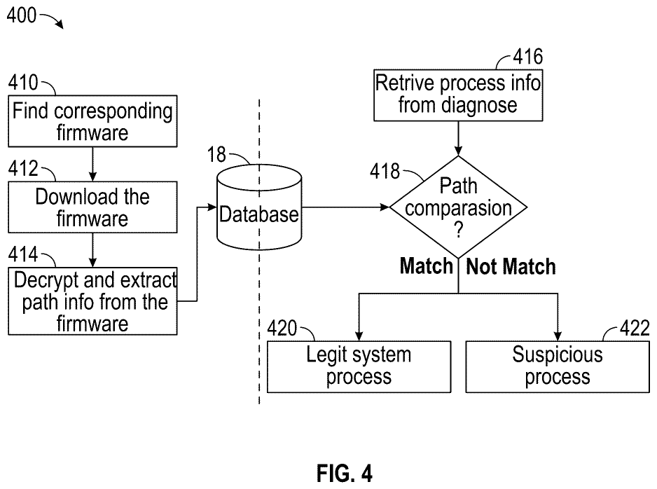

FIG. 4 illustrates a block diagram 400 depicting path extraction from the firmware 56 and real-time process monitoring for a continuous cycle of verification, which can be, in certain aspects, implemented with the example process 300 of FIG. 3.

As depicted at block 410, the processor 44 of the security service 14 searches for a corresponding firmware specific to a mobile operating system 70 of the at least one mobile computing device 10. Following the identification of the appropriate firmware, the processor 44 of the security service 14 proceeds with the integrity verification, and then downloads or retrieves the firmware 56 from official sources, as depicted at block 412. In certain aspects, this includes verifying the authenticity and integrity of the firmware 56 using cryptographic hash checks to ensure that it has not been tampered with or corrupted during transit.

Upon successful verification and download, the processor 44 of the security service 14 decrypts the firmware 56, if encrypted, followed by the extraction of all relevant executable and system file paths (e.g., the set of legitimate process executable paths 58), as depicted at block 414. These extracted paths are crucial for the subsequent verification of running processes on the mobile device (e.g., the at least one mobile computing device 10). The paths are then systematically stored in a structured path database (e.g., the database 18), which is specially designed for quick retrieval and efficient data management, facilitating rapid comparisons, and checks.

Concurrently with these steps depicted at blocks 410, 412, 414, the processor 44 of the security service 14 extracts process information (e.g., diagnostic process information 60) directly from the at least one mobile computing device 10 using, for example, a system diagnose function, as depicted at block 416. This diagnostic tool is crucial for gathering comprehensive information about the processes (e.g., diagnostic process information 60) currently running on the at least one mobile computing device 10, including their executable paths (e.g., the set of legitimate process executable paths 58). This real-time process information (e.g., diagnostic process information 60) is essential for the next steps of comparison, as depicted at decision block 418, and verification, as depicted at blocks 420 and 422 against the stored paths (e.g., the set of legitimate process executable paths 58) in the database 18, ensuring the integrity and legitimacy of each process active on the at least one mobile computing device 10. For example, when the processor 44 of the security service 14 determines that the target executable process 62 of the diagnostic process information 60 matches a legitimate process executable path of the set of legitimate process executable paths 58, the processor 44 of the security service 14 identifies the target executable process 62 as a legit system process. On the other hand, when the processor 44 of the security service 14 determines that the target executable process 62 of the diagnostic process information 60 does not match a legitimate process executable path of the set of legitimate process executable paths 58, the processor 44 of the security service 14 identifies the target executable process 62 as a potentially suspicious process 64.

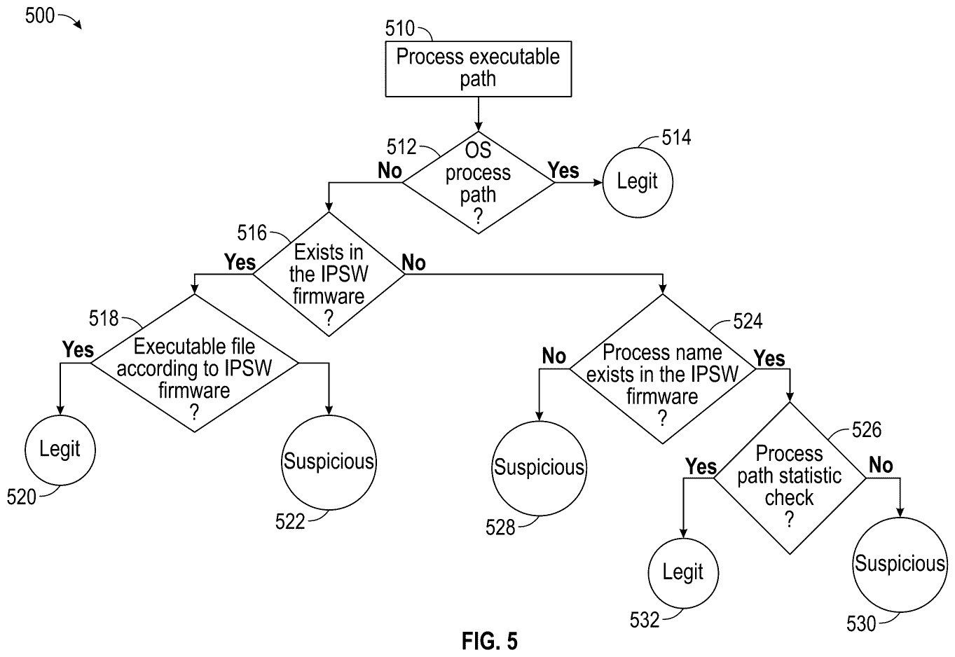

FIG. 5 illustrates a block diagram 500 depicting systematic visualization of precision and adaptability in maintaining the security integrity of mobile operating systems of the example process 300 of FIG. 3. The block diagram 500 illustrates the process used to determine if a running process on a mobile device is suspicious, enhancing the security mechanism described in the earlier stages of our system. This flowchart encapsulates a multi-condition analysis that checks the origins and legitimacy of each process's executable path. The decision-making process is structured into a series of steps and conditions designed to evaluate potential discrepancies that could indicate security threats.

At block 510, the processor 44 of the security service 14 checks if the running process's executable path of the diagnostic process information 60 is located outside the standard application container directories. As depicted at decision block 512, if the path is found within these directories, the process is deemed legitimate, as depicted at block 514, and no further action is taken. However, if the path lies outside these directories, the processor 44 of the security service 14 proceeds to the next condition.

At block 516, the processor 44 of the security service 14 verifies whether the executable path of the diagnostic process information 60 is listed in the firmware directory. If the path is found, the processor 44 of the security service 14 checks, as depicted at decision block 518, if the path is marked as executable in the firmware 56. If the path is marked as executable in the firmware 56, it is deemed legitimate, as depicted at block 520. If the path is not marked as executable in the firmware 56, it is deemed suspicious, as depicted at block 522.

If the path is not listed in the firmware at block 516, the processor 44 of the security service 14 proceeds to decision block 524. At the block 524, the processor 44 of the security service 14 checks if the process name extracted from the executable path exists under a different executable path in the firmware. If the process name is found, suggesting potential path redirection or spoofing, the processor 44 of the security service 14 proceeds to the final decision block 526. If the process name is not found, as depicted at block 528, the process is immediately marked as suspicious due to the absence of any legitimate reference in the firmware.

At the final decision block 526, the processor 44 of the security service 14 performs a statistical evaluation of how common the process's executable path is within the database 18. Then the processor 44 of the security service 14 sets a threshold to flag rare and unusual paths as potentially suspicious (e.g., potentially suspicious process 64), as depicted at block 530. If the processor 44 of the security service 14 determines that the process's executable path is within the database 18, it is identified as legitimate, as depicted at block 532. This comprehensive approach ensures a robust evaluation mechanism, significantly reducing the likelihood of overlooking sophisticated malware or unauthorized modifications while minimizing disruptions caused by false alerts.

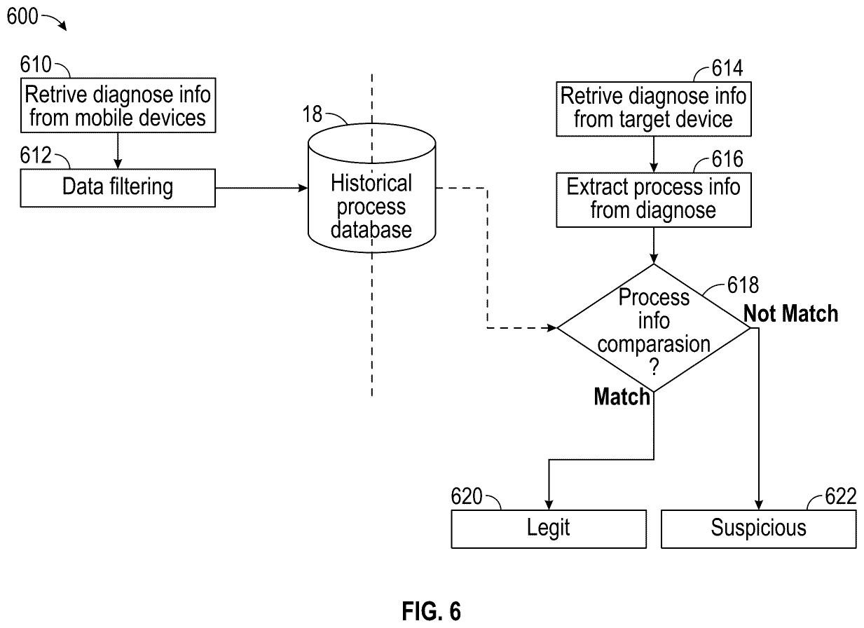

FIG. 6 is a block diagram 600 depicting the database 18 utilizing historical processes 68. By extracting system diagnose data (e.g., the historical processes 68) from the at least one mobile computing device 10, the processor 44 of the security service 14 captures and stores essential process and user information in a historical process database (e.g., the database 18). This database 18 serves as a foundational component in comparing current process data of diagnostic process information 60 to historical norms (e.g., the historical processes 68), thereby identifying potential unauthorized or suspicious activities.

The comprehensive workflow illustrates both the generation of a historical process information database (e.g., the database 18) with the historical processes 68 that are extracted and its utilization in determining the legitimacy of processes on the at least one mobile computing device 10. As depicted at block 610, the processor 44 of the security service 14 retrieves the diagnostic information (e.g., the diagnostic process information 60) from the at least one mobile computing device 10. In certain aspects, the diagnostic process information 60 can include, but is not limited to, detailed data about running processes, such as process paths, process identifiers (PIDs), and user identifiers (UIDs).

As depicted at block 612, the processor 44 of the security service 14 then proceeds to filter data, where it extracts security-related process information from the diagnostic process information 60 that was retrieved. This filtering focuses on isolating critical details such as, but not limited to, the process execution path, PID, UID, mobile OS versions and device models, which are essential for security analysis. The filtered process information is then stored into the historical process database (e.g., the database 18), creating a repository of known process behaviors and execution contexts (e.g., the historical processes 68) for future reference.

Simultaneously, as depicted at 614, the processor 44 of the security service 14, via the extraction agent 36, which involves retrieving diagnostic information (e.g., the diagnostic process information 60) from the at least one mobile computing device 10 intended for analysis. Following retrieval, the processor 44 of the security service 14, via the extraction agent 36, conducts data extraction, extracting process information from the diagnostics of the target device (e.g., the at least one mobile computing device 10), similar to the data filtering at block 612.

At decision block 618, the processor 44 of the security service 14 compares the extracted process information (e.g., the diagnostic process information 60) from the at least one mobile computing device 10 with the historical processes 68 stored in the historical process database (e.g., the database 18), for example, by querying the database 18 for the historical processes 68 to determine prevalence of the potentially suspicious process 64 across multiple (mobile) computing devices that are similarly running the mobile operating system 70 as the at least one mobile computing device 10. This comparison checks for matches in, for example, but not limited to, process paths, PIDs, and UIDs to determine if the processes running on the target device (e.g., the at least one mobile computing device 10) align with historically recorded legitimate processes (e.g., the historical processes 68).

If a match is found at the comparison at decision block 618, the processor 44 of the security service 14 considers the process as legitimate, as depicted at block 620, and proceeds to mark the process as legitimate. This indicates that the process (e.g., the target executable process 62) conforms to expected behaviors and does not pose a security threat.

If no match is found, the processor 44 of the security service 14 advances to block 622, marking the process (e.g., the target executable process 62) as suspicious. This prompts further investigation or immediate action to address potential security risks associated with the unrecognized or anomalous process.

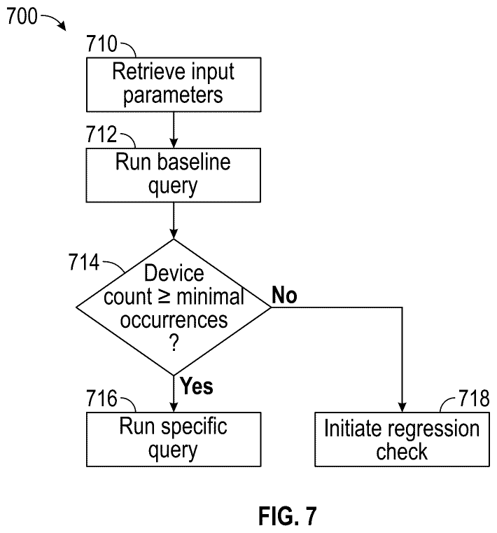

FIG. 7 illustrates an example process 700 depicting initial steps of anomaly detection of the example process 300 of FIG. 3.

The comparison at decision block 618 of FIG. 6, referring to anomaly detection method, depicted in FIG. 7, the anomaly detection process 700 includes, as depicted at block 710, the processor 44 of the security service 14 retrieving the input parameters, which include the process execution path, the mobile OS version, and the device model. The processor 44 of the security service 14 then performs, as depicted at block 712, a baseline query to determine the baseline device count (e.g., baseline number of devices) by checking the number of devices containing events with any process execution path values from the desired mobile OS version. The processor 44 of the security service 14 determines if the baseline device count meets or exceeds the minimal occurrences threshold defined in the configurations.

If the baseline device count is greater than or equal to the minimal occurrences threshold, the processor 44 of the security service 14 proceeds to block 716 to perform a specific query to determine the specific device count by checking the number of devices containing the specific process execution path from the desired mobile OS version. If, at decision block 714, the baseline device count is found to be less than the minimal occurrences threshold, the processor 44 of the security service 14 initiates, as depicted a block 718, a regression check. In this regression check, the processor 44 of the security service 14 defers the anomaly detection due to insufficient data and schedules a reevaluation of all related devices once the number of devices reporting data for the specific mobile OS version crosses the minimal occurrences threshold. This ensures that the anomaly detection is applied consistently and accurately as more data becomes available, maintaining the integrity and effectiveness of the security analysis.

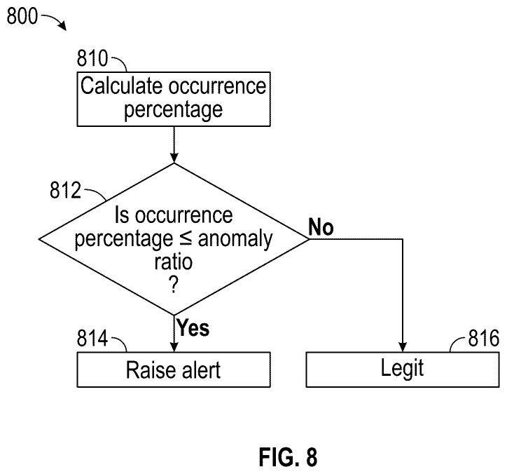

FIG. 8 illustrates an example process 700 depicting further steps of the example process 700 of FIG. 7.

As depicted at block 510, the processor 44 of the security service 14 calculates the occurrence percentage by dividing the specific device count obtained at block 716 by the baseline device count and multiplying by 100%. The processor 44 of the security service 14 compares, as depicted at block 812, the calculated occurrence percentage to the predefined anomaly ratio to determine if the calculated occurrence percentage is less than or equal to the predefined anomaly ratio. If the calculated occurrence percentage is less than or equal to the predefined anomaly ratio, then the processor 44 of the security service 14 raises the alert 66 indicating a suspicious process executable path, as depicted at block 814. If the calculated occurrence percentage is greater than the predefined anomaly ratio, the processor 44 of the security service 14 considers the process executable path as legitimate and allows it to pass through the system without raising an alert, as depicted at block 816.

This structured approach depicted in FIGS. 7 and 8 provides systematic method for detecting anomalies in process execution paths using historical process data. By incorporating configurable thresholds for minimal occurrences and anomaly ratios, the system ensures flexibility and adaptability to different operating environments and security requirements. The regression check mechanism, as depicted at block 718 in FIG. 7, further enhances reliability by ensuring that anomaly detection is deferred until sufficient data is available, thereby reducing false positives and improving overall security analysis accuracy.

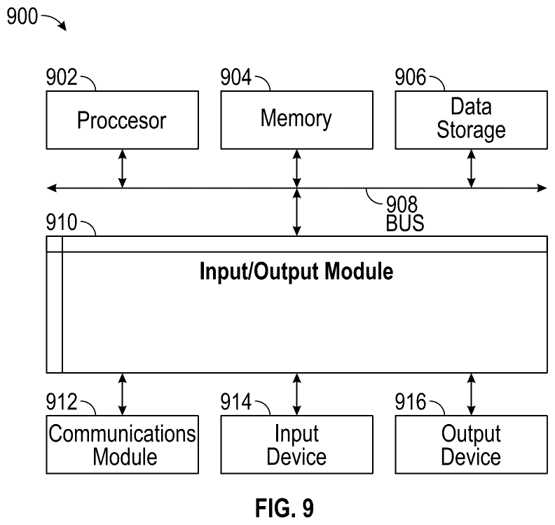

FIG. 9 is a block diagram illustrating an example computer system 900 with which the at least one mobile computing device 10, such as a first mobile computing device 10a, the mobile device management service 12, the security service 14, the push notification service 16, and the database 18 of FIG. 2 can be implemented. In certain aspects, the computer system 900 may be implemented using hardware or a combination of software and hardware, either in a dedicated server, or integrated into another entity, or distributed across multiple entities.

Computer system 900 (e.g., the at least one mobile computing device 10, such as a first mobile computing device 10a, the mobile device management service 12, the security service 14, the push notification service 16, and the database 18) includes a bus 908 or other communication mechanism for communicating information, and a processor 902 (e.g., the processor 32, 40, 44, 48, 52) coupled with bus 908 for processing information. According to one aspect, the computer system 900 can be a cloud computing server of an IaaS that is able to support PaaS and SaaS services.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., the memory 34, 42, 46, 50, 54), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer readable medium for execution by, or to control the operation of, the computer system 900.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network, such as in a cloud-computing environment. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Example input/output modules 910 include data ports such as USB ports. In addition, input/output module 910 may be provided in communication with processor 902, so as to enable near area communication of computer system 900 with other devices. The input/output module 910 may provide, for example, for wired communication in some implementations, or for wireless communication in other implementations, and multiple interfaces may also be used. The input/output module 910 is configured to connect to a communications module 912. Example communications modules 912 (e.g., the communications module 22, 24, 26, 28, 30) include networking interface cards, such as Ethernet cards and modems.

In certain aspects, the input/output module 910 is configured to connect to a plurality of devices, such as an input device 914 and/or an output device 916. Example input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device.

According to one aspect of the present disclosure the at least one mobile computing device 10, such as a first mobile computing device 10a, the mobile device management service 12, the security service 14, the push notification service 16, and the database 18 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. Processor 902 may process the executable instructions and/or data structures by remotely accessing the computer program product, for example by downloading the executable instructions and/or data structures from a remote server through communications module 912 (e.g., as in a cloud-computing environment). In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. For example, some aspects of the subject matter described in this specification may be performed on a cloud-computing environment. Accordingly, in certain aspects a user of systems and methods as disclosed herein may perform at least some of the steps by accessing a cloud server through a network connection. Further, data files, circuit diagrams, performance specifications and the like resulting from the disclosure may be stored in a database server in the cloud-computing environment, or may be downloaded to a private storage device from the cloud-computing environment.

The term “machine-readable storage medium” or “computer-readable medium” as used herein refers to any medium or media that participates in providing instructions or data to processor 902 for execution. The term “storage medium” as used herein refers to any non-transitory media that store data and/or instructions that cause a machine to operate in a specific fashion. Such a medium may take many forms, including, but not limited to, non-volatile media, volatile media, and transmission media.

As used in this specification of this application, the terms “computer-readable storage medium” and “computer-readable media” are entirely restricted to tangible, physical objects that store information in a form that is readable by a computer. These terms exclude any wireless signals, wired download signals, and any other ephemeral signals. Storage media is distinct from but may be used in conjunction with transmission media. Transmission media participates in transferring information between storage media. For example, transmission media includes coaxial cables, copper wire and fiber optics, including the wires that comprise bus 908. Transmission media can also take the form of acoustic or light waves, such as those generated during radio-wave and infra-red data communications. Furthermore, as used in this specification of this application, the terms “computer”, “server”, “processor”, and “memory” all refer to electronic or other technological devices. These terms exclude people or groups of people. For the purposes of the specification, the terms display or displaying means displaying on an electronic device.

In one aspect, a method may be an operation, an instruction, or a function and vice versa. In one aspect, a clause or a claim may be amended to include some or all of the words (e.g., instructions, operations, functions, or components) recited in either one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for”.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method for process path integrity, the computer-implemented method comprising:
extracting, from a firmware associated with a mobile computing device, a set of legitimate process executable paths;
retrieving, from the mobile computing device, diagnostic process information of processes running on the mobile computing device;
identifying, based on determining a target executable process of the diagnostic process information retrieved from the mobile computing device is matchless with the set of legitimate process executable paths, the target executable process as a potentially suspicious process;
analyzing the potentially suspicious process to determine legitimacy; and
triggering, based on determining the potentially suspicious process as an illegitimate process, an alert.

2. The computer-implemented method of claim 1, further comprising storing the set of legitimate process executable paths in a database.

3. The computer-implemented method of claim 2, further comprising updating the set of legitimate process executable paths in the database responsive to release of a new version of the firmware.

4. The computer-implemented method of claim 1, wherein the extracting, from the firmware associated with the mobile computing device, the set of legitimate process executable paths further comprises:
extracting the set of legitimate process executable paths from the firmware of a mobile operating system of the mobile computing device.

5. The computer-implemented method claim 1, wherein the extracting, from the firmware associated with the mobile computing device, the set of legitimate process executable paths further comprises:
downloading the firmware from an official source;
verifying integrity of the firmware; and
extracting, based on verifying the integrity of the firmware, the set of legitimate process executable paths.

6. The computer-implemented method of claim 5, further comprising decrypting, based on verifying the integrity of the firmware, the firmware.

7. The computer-implemented method of claim 1, wherein analyzing the potentially suspicious process to determine legitimacy comprises:
querying a database for historical processes to determine prevalence of the potentially suspicious process across multiple devices running a mobile operating system version that is running on the mobile computing device;
calculating an occurrence percentage based on dividing a number of devices containing the potentially suspicious process by a baseline number of devices containing any process executable paths from the mobile operating system version;
comparing the occurrence percentage to a predefined anomaly ratio; and
triggering the alert based on determining the occurrence percentage is less than or equal to the predefined anomaly ratio.

8. A system comprising:
a memory comprising instructions; and
a processor configured to execute the instructions which, when executed, cause the processor to:
extract, from a firmware associated with a mobile computing device, a set of legitimate process executable paths;
retrieve, from the mobile computing device, diagnostic process information of processes running on the mobile computing device;
identify, based on determining a target executable process of the diagnostic process information retrieved from the mobile computing device is matchless with the set of legitimate process executable paths, the target executable process as a potentially suspicious process;
analyze the potentially suspicious process to determine legitimacy; and
trigger, based on determining the potentially suspicious process as an illegitimate process, an alert.

9. The system of claim 8, wherein the processor is further configured to execute the instructions which, when executed, cause the processor to:
store the set of legitimate process executable paths in a database.

10. The system of claim 9, wherein the processor is further configured to execute the instructions which, when executed, cause the processor to:
update the set of legitimate process executable paths in the database responsive to release of a new version of the firmware.

11. The system of claim 8, wherein the processor is configured to execute the instructions which, when executed, cause the processor to extract, from the firmware associated with the mobile computing device, the set of legitimate process executable paths further causes the processor to:
extract the set of legitimate process executable paths from the firmware associated with a mobile operating system of the mobile computing device.

12. The system of claim 8, wherein the processor is configured to execute the instructions which, when executed, cause the processor to extract, from the firmware associated with the mobile computing device, the set of legitimate process executable paths further causes the processor to:
download the firmware from an official source;
verify integrity of the firmware; and
extract, based on verifying the integrity of the firmware, the set of legitimate process executable paths.

13. The system of claim 12, wherein the processor is further configured to execute the instructions which, when executed, cause the processor to:
decrypt, based on verifying the integrity of the firmware, the firmware.

14. The system of claim 13, wherein the processor is configured to execute the instructions which, when executed, cause the processor to analyze the potentially suspicious process to determine legitimacy further causes the processor to:
query a database for historical processes to determine prevalence of the potentially suspicious process across multiple devices running a mobile operating system version that is running on the mobile computing device;
calculate an occurrence percentage based on dividing a number of devices containing the potentially suspicious process by a baseline number of devices containing any process executable paths from the mobile operating system version;
compare the occurrence percentage to a predefined anomaly ratio; and
trigger the alert based on determining the occurrence percentage is less than or equal to the predefined anomaly ratio.

15. A non-transitory machine-readable storage medium comprising machine-readable instructions for causing a processor to execute a method, the method comprising:
extracting, from a firmware associated with a mobile computing device, a set of legitimate process executable paths;
retrieving, from the mobile computing device, diagnostic process information of processes running on the mobile computing device;
identifying, based on determining a target executable process of the diagnostic process information retrieved from the mobile computing device is matchless with the set of legitimate process executable paths, the target executable process as a potentially suspicious process;
analyzing the potentially suspicious process to determine legitimacy; and
triggering, based on determining the potentially suspicious process as an illegitimate process, an alert.

16. The non-transitory machine-readable storage medium of claim 15, wherein the method further comprises storing the set of legitimate process executable paths in a database.

17. The non-transitory machine-readable storage medium of claim 15, wherein the extracting, from the firmware associated with the mobile computing device, the set of legitimate process executable paths further comprises:
extracting the set of legitimate process executable paths from the firmware of a mobile operating system of the mobile computing device.

18. The non-transitory machine-readable storage medium of claim 15, wherein the extracting, from the firmware associated with the mobile computing device, the set of legitimate process executable paths further comprises:
downloading the firmware from an official source;
verifying integrity of the firmware; and
extracting, based on verifying the integrity of the firmware, the set of legitimate process executable paths.

19. The non-transitory machine-readable storage medium of claim 18, wherein the method further comprises decrypting, based on verifying the integrity of the firmware, the firmware.

20. The non-transitory machine-readable storage medium of claim 15, wherein analyzing the potentially suspicious process to determine legitimacy further comprises:
querying a database for historical processes to determine prevalence of the potentially suspicious process across multiple devices running a mobile operating system version that is running on the mobile computing device;
calculating an occurrence percentage based on dividing a number of devices containing the potentially suspicious process by a baseline number of devices containing any process executable paths from the mobile operating system version;
comparing the occurrence percentage to a predefined anomaly ratio; and
raising the alert based on determining the occurrence percentage is less than or equal to the predefined anomaly ratio.
